(19) United States
(12) Patent Application Publication
(10) Pub. No.: US 2021/0033107 A1
(43) Pub. Date: Feb. 4, 2021

(54) CENTRIFUGAL COMPRESSOR AND TURBOCHARGER INCLUDING THE SAME

(71) Applicant: MITSUBISHI HEAVY INDUSTRIES ENGINE & TURBOCHARGER, LTD., Sagamihara-shi, Kanagawa (JP)

(72) Inventors: Yutaka FUJITA, Tokyo (JP); Hironori HONDA, Tokyo (JP); Nobuhito OKA, Sagamihara-shi (JP)

(73) Assignee: MITSUBISHI HEAVY INDUSTRIES ENGINE & TURBOCHARGER, LTD., Sagamihara-shi, Kanagawa (JP)

(21) Appl. No.: 16/969,075

(22) PCT Filed: Apr. 4, 2018
(86) PCT No.: PCT/JP2018/014422

§ 371 Date: Aug. 11, 2020

(51) Int. Cl. F04D 29/44

(52) U.S. Cl. CPC F04D 29/444; F05D 2250/52; F05D 2220/40

(57) ABSTRACT

In a centrifugal compressor including an impeller rotatably disposed in a housing, the housing includes a shroud wall and a hub wall, which define a diffuser passage communicating with an outlet of the impeller. The diffuser flow passage includes a pinched part configured such that the shroud wall is closer to the hub wall radially outward of the centrifugal compressor from the outlet of the impeller, and a parallel part communicating with the pinched part on a radially outer side of the centrifugal compressor than the pinched part, the parallel part being configured such that the shroud wall and the hub wall are parallel to each other. The shroud wall has a surface facing the impeller and the hub wall, the surface having a cross-sectional shape where a tangent line exists at any position in a cross-section including an axis of the impeller.

### TECHNICAL FIELD

The present disclosure relates to a centrifugal compressor and a turbocharger including the same.

### BACKGROUND

A centrifugal compressor such as a turbocharger includes a diffuser passage and a scroll passage on a discharge side of an impeller. A fluid compressed by the impeller flows into the scroll passage after a flow velocity thereof is decreased in the diffuser passage and a part of a dynamic pressure component thereof is converted to a static pressure. The diffuser passage generally includes a shape in which two walls defining the diffuser passage are parallel to each other (parallel walls), and a shape which includes a portion where an interval between the two walls decreases radially outward (pinched wall). For example, Patent Document 1 describes a centrifugal compressor including a diffuser passage formed by a pinched wall.

### CITATION LIST

### Patent Literature

Patent Document 1: JP6112223B

### SUMMARY

### Technical Problem

As the diffuser passage formed by the pinched wall, for example, as shown in FIG. 6, in a diffuser passage 100 defined between a shroud wall 102 and a hub wall 103, a configuration is assumed in which the diffuser passage 100 includes a pinched part 110 and a parallel part 111. In the pinched part 110, the shroud wall 102 is inclined at a constant inclination so as to be closer to the hub wall 103 radially outward from an outlet portion 101 of an impeller 105. In the parallel part 111, the shroud wall 102 and the hub wall 103 are parallel to each other on the radially outer side of the pinched part 110. In a cross-section including an axis L of the impeller 105, an angle λ is formed by a straight line L₃ and a tangent line. The straight line L₃ is obtained by extending a radially outermost part 106a1 of an outer peripheral edge part 106a of a blade 106 in the impeller 105 radially outward. The tangent line is at any position on the surface of the shroud wall 102. Moreover, regarding a distance R radially outward from the axis L of the impeller 105, R₀ is a distance from the axis L of the impeller 105 to the outlet portion 101 of the impeller 105, and R₁ is a distance from the axis L of the impeller 105 to a boundary portion 104 between the pinched part 110 and the parallel part 111.

Referring to FIG. 7, in an R-λ plane where the abscissa indicates R and the ordinate indicates λ, the relationship between R and λ is represented as λ=f(R) by a function f. In the range of R≤R₀, the surface of the shroud wall 102 has a smooth decreasing function. However, λ discontinuously increases at R=R₀ and in the range of R₀≤R<R₁, the shroud wall 102 is inclined at the constant inclination, and thus λ has a constant value. Moreover, λ discontinuously decreases at R=R₁, and the shroud wall 102 and the hub wall 103 are parallel to each other in the range of R≥R₁, and thus λ has a constant value. Thus, discontinuous portions exist on the shroud wall 102 in the outlet portion 101 of the impeller 105, and the boundary portion 104 between the pinched part 110 and the parallel part 111. The problem arises in that a loss or separation occurs in such discontinuous portions.

In view of the above, an object of at least one embodiment of the present disclosure is to provide a centrifugal compressor suppressing occurrence of a loss or separation in the diffuser passage and a turbocharger including the same.

### Solution to Problem

(1) A centrifugal compressor according to at least one embodiment of the present invention is a centrifugal compressor including an impeller rotatably disposed in a housing. The housing includes a shroud wall and a hub wall, which define a diffuser passage communicating with an outlet of the impeller. The diffuser flow passage includes a pinched part configured such that the shroud wall is closer to the hub wall radially outward of the centrifugal compressor from the outlet of the impeller, and a parallel part communicating with the pinched part on a radially outer side of the centrifugal compressor than the pinched part, the parallel part being configured such that the shroud wall and the hub wall are parallel to each other. The shroud wall has a surface facing the impeller and the hub wall, the surface having a cross-sectional shape where a tangent line exists at any position in a cross-section including an axis of the impeller.

With the above configuration (1), since the surface of the shroud wall facing the impeller and the hub wall has the cross-sectional shape where the tangent line exists at any position in the cross-section including the axis of the impeller, the surface of the shroud wall has a smooth shape, and a discontinuous portion does not exist in the surface of the shroud wall. Thus, it is possible to suppress occurrence of a loss or separation in the diffuser passage.

(2) In some embodiments, in the above configuration (1), regarding a distance R radially outward of the centrifugal compressor from the axis of the impeller, provided that R₀ is a distance from the axis of the impeller to the outlet of the impeller, and R₁ is a distance from the axis of the impeller to a boundary portion between the pinched part and the parallel part, the cross-sectional shape in a range of R₀≤R≤R₁ is formed by a curved line curved into a convex shape with respect to the hub wall.

With the above configuration (2), since the cross-sectional shape of the surface of the shroud wall in the range of R₀≤R≤R₁ is formed by the curved line curved into the convex shape with respect to the hub wall, the curved line in the range of R₀≤R≤R₁can smoothly be connected to each of a cross-section of the surface of the shroud wall in the range of R≤R₀ and a cross-section of the surface of the shroud wall in the range of R≥R₁. Thus, it is possible to configure the pinched part so the discontinuous portion is not formed in the surface of the shroud wall.

(3) In some embodiments, in the above configuration (1), regarding a distance R radially outward of the centrifugal compressor from the axis of the impeller, provided that R₀ is a distance from the axis of the impeller to the outlet of the impeller, and R₁ is a distance from the axis of the impeller to a boundary portion between the pinched part and the parallel part, the cross-sectional shape in a range of R₀≤R≤R₁ is formed by a curved line including a first curved line curved into a concave shape with respect to the hub wall in a range of R₀≤R≤R₁ (R₀<R₂<R₁), and a second curved line curved into a convex shape with respect to the hub wall in a range of R₂≤R≤R₁.

If the cross-sectional shape of the surface of the shroud wall in the range of R₀≤R≤R₁ is formed by only the curved line curved into the convex shape with respect to the hub wall, a constraint may be imposed on the shape of the diffuser passage. However, with the above configuration (3), since the cross-sectional shape in the range of R₀≤R≤R₁ is formed by the curved line including the first curved line curved into the concave shape with respect to the hub wall in the range of R₀≤R≤R₂(R₀<R₂<R₁), and the second curved line curved into the convex shape with respect to the hub wall in the range of R₂≤R≤R₁, it is possible to configure the pinched part so a discontinuous portion is not formed in the surface of the shroud wall while relaxing the constraint on the shape of the diffuser passage.

(4) In some embodiments, in any one of the above configurations (1) to (3), provided that, in the cross-section including the axis of the impeller, λ is an angle between the tangent line and a straight line obtained by extending a radially outermost part of an outer peripheral edge part of a blade in the impeller radially outward, λ=f(R) represents a relationship between the R and the λ by a function f in a range of R₀≤R<R₁, and f′(R) is a first derivative of f(R), f′(R)<0 holds in the range of R₀≤R<R₁.

With the above configuration (4), since the shroud wall is configured to be smoothly closer to the hub wall radially outward in the pinched part, it is possible to suppress the occurrence of the loss or separation in the diffuser passage.

(5) A turbocharger according to at least one embodiment of the present invention includes the centrifugal compressor according to any one of the above configurations (1) to (4).

With the above configuration (5), since the surface of the shroud wall facing the impeller and the hub wall has the cross-sectional shape where the tangent line exists at any position in the cross-section including the axis of the impeller, the surface of the shroud wall has a smooth shape, and a discontinuous portion does not exist in the surface of the shroud wall. Thus, it is possible to suppress the occurrence of the loss or separation in the diffuser passage.

### Advantageous Effects

According to at least one embodiment of the present disclosure, since the surface of the shroud wall facing the impeller and the hub wall has the cross-sectional shape where the tangent line can exist at any position in the cross-section including the axis of the impeller, the surface of the shroud wall has a smooth shape, and a discontinuous portion does not exist in the surface of the shroud wall. Thus, it is possible to suppress occurrence of a loss or separation in the diffuser passage.

### BRIEF DESCRIPTION OF DRAWINGS

FIG. 1 is a cross-sectional view of a centrifugal compressor according to Embodiment 1 of the present disclosure.

FIG. 2 is a partially enlarged cross-sectional view of a diffuser passage in the centrifugal compressor according to Embodiment 1 of the present disclosure.

FIG. 3 is a schematic graph showing the relationship between R and λ in the diffuser passage in the centrifugal compressor according to Embodiment 1 of the present disclosure.

FIG. 4 is a partially enlarged cross-sectional view of the diffuser passage in the centrifugal compressor according to Embodiment 2 of the present disclosure.

FIG. 5 is a schematic graph showing the relationship between R and λ in the diffuser passage in the centrifugal compressor according to Embodiment 2 of the present disclosure.

FIG. 6 is a schematic cross-sectional view of a conventional centrifugal compressor.

FIG. 7 is a schematic graph showing the relationship between R and λ in a diffuser passage in the conventional centrifugal compressor.

### DETAILED DESCRIPTION

Embodiments of the present invention will now be described in detail with reference to the accompanying drawings. However, the scope of the present invention is not limited to the following embodiments. It is intended that dimensions, materials, shapes, relative positions and the like of components described in the embodiments shall be interpreted as illustrative only and not intended to limit the scope of the present invention.

A centrifugal compressor according to some embodiments of the present disclosure to be shown below will be described by taking a centrifugal compressor of a turbocharger as an example. However, the centrifugal compressor in the present disclosure is not limited to the centrifugal compressor of the turbocharger, and may be any centrifugal compressor operating independently. In the following description, a fluid compressed by the compressor is air. However, the fluid can be replaced with any fluid.

### EMBODIMENT 1

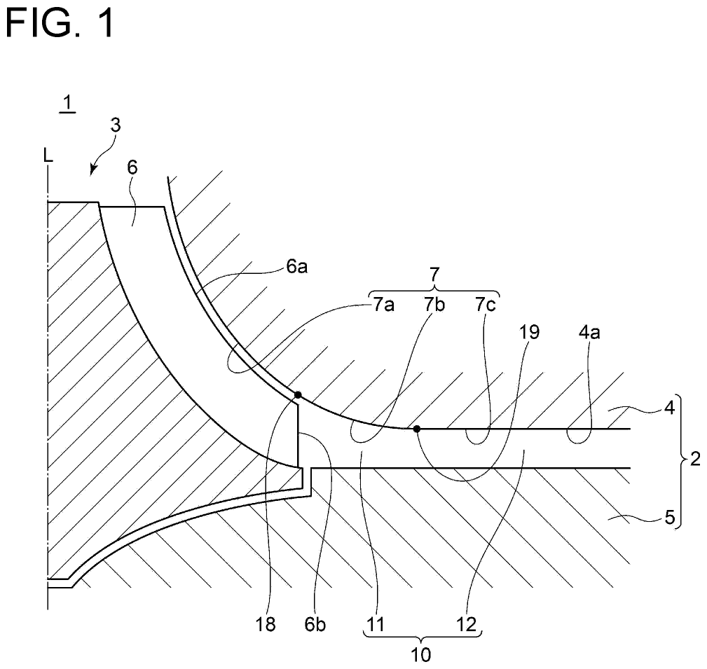

As shown in FIG. 1, a centrifugal compressor 1 according to Embodiment 1 of the present disclosure includes a housing 2 and an impeller 3 disposed so as to be rotatable about the axis L in the housing 2. The housing 2 includes a shroud wall 4 and a hub wall 5. Between the shroud wall 4 and the hub wall 5, a diffuser passage 10 communicating with an outlet of the impeller 3 along the periphery of the impeller 3 is defined.

The diffuser passage 10 includes a pinched part 11 and a parallel part 12. The pinched part 11 extends radially outward of the centrifugal compressor 1 (to be simply referred to as “radially outward” hereinafter) from the outlet of the impeller 3. The parallel part 12 communicates with the pinched part 11 on the radially outer side of the pinched part 11 and extends radially outward. The pinched part 11 is configured such that the shroud wall 4 is closer to the hub wall 5 radially outward. That is, the pinched part 11 is configured such that a flow passage width in the direction of the axis L of the impeller 3 decreases radially outward. The parallel part 12 is configured such that the shroud wall 4 and the hub wall 5 are parallel to each other.

The shroud wall 4 has a surface 4a facing the impeller 3 and the hub wall 5. The surface 4a has a cross-sectional shape 7 formed by a curved line 7a, a curved line 7b, and a straight line 7c in a cross-section including the axis L of the impeller 3. The curved line 7a is curved smoothly into a convex shape in a portion along an outer peripheral edge part 6a of a blade 6 in the impeller 3. The curved line 7b is smoothly curved into a convex shape in a portion defining the pinched part 11. The straight line 7c horizontally extends radially outward in a portion defining the parallel part 12. The curved line 7a and the curved line 7b are smoothly connected in a boundary portion 18 positioned in the outlet of the impeller 3. The curved line 7b and the straight line 7c are smoothly connected in a boundary portion 19 positioned radially outer side of the boundary portion 18.

Since, in the cross-section including the axis L of the impeller 3, the curved lines 7a and 7b are each smoothly curved into the convex shape, the curved line 7a and the curved line 7b are smoothly connected, and the curved line 7b and the straight line 7c are smoothly connected, the surface 4a of the shroud wall 4 continues smoothly, and a discontinuous portion, such as a sharp projection or recess, does not exist in the surface 4a. A trailing edge part 6b of the blade 6 in the impeller 3 is configured to be parallel to the axis L of the impeller 3.

Next, the fact that the surface 4a of the shroud wall 4 has the smooth continuous shape will be described in more detail.

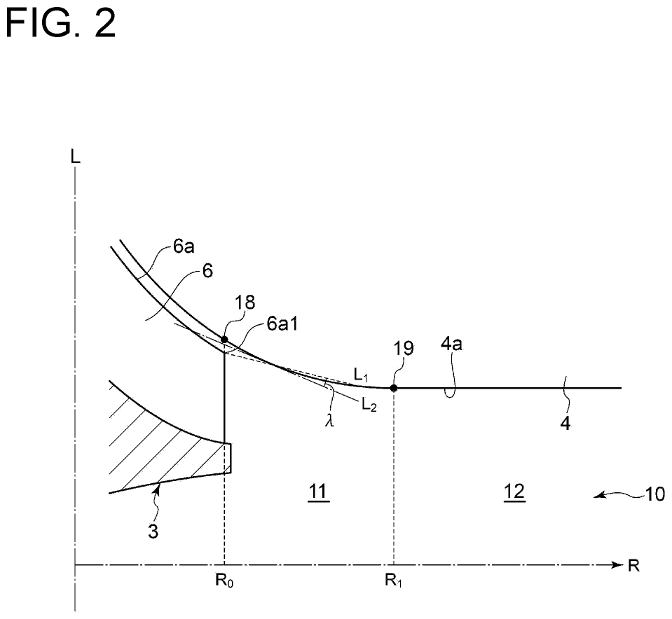

As shown in FIG. 2, in the cross-section including the axis L of the impeller 3, the angle λ is formed by the straight line Li and a tangent line L₂. The straight line L₁ is obtained by extending the radially outermost part 6a1 of the outer peripheral edge part 6a of the blade 6 in the impeller 3 radially outward. The tangent line L₂ is at any position on the surface 4a. Moreover, regarding the distance R radially outward from the axis L of the impeller 3, R₀ is the distance from the axis L of the impeller 3 to the outlet of the impeller 3, that is, the boundary portion 18, and R₁ is the distance from the axis L of the impeller 3 to the boundary portion 19 between the pinched part 11 and the parallel part 12.

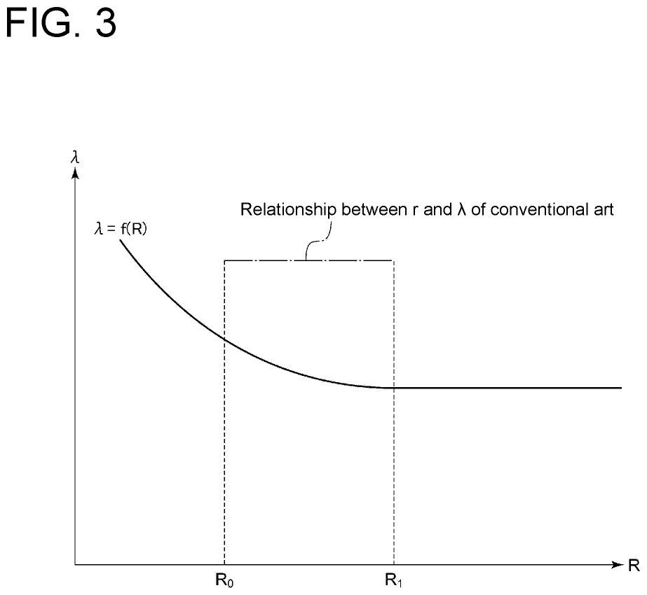

As shown in FIG. 3, in the R−λ plane where the abscissa indicates R and the ordinate indicates λ, the relationship between R and λ is represented as λ=f(R) by the function f. In the range of R≤R₀, the surface 4a is along the outer peripheral edge part 6a of the blade 6 (see FIG. 2), and thus the function λ=f(R) is a smooth decreasing function which is convex downward. In the range of R₀≤R<R₁, the shroud wall 4 is configured to be closer to the hub wall 5 radially outward (see FIG. 1), and thus the function λ=f(R) is a smooth decreasing function which is convex downward. In the range of R≥R₁, the shroud wall 4 and the hub wall 5 are parallel to each other (see FIG. 1), and thus λ has a constant value, that is, the function λ=f(R) is a straight line parallel to the R axis.

As described above, since the surface 4a has the smooth continuous cross-sectional shape in the cross-section including the axis L of the impeller 3 (see FIG. 2), a discontinuous point does not exist in the function λ=f(R), and the function λ=f(R) is differentiable in any R. In other words, the surface 4a can have a cross-sectional shape where the tangent line L₂ can exist at any position in the cross-section including the axis L of the impeller 3. The shape is a smooth continuous shape where the discontinuous portion does not exist.

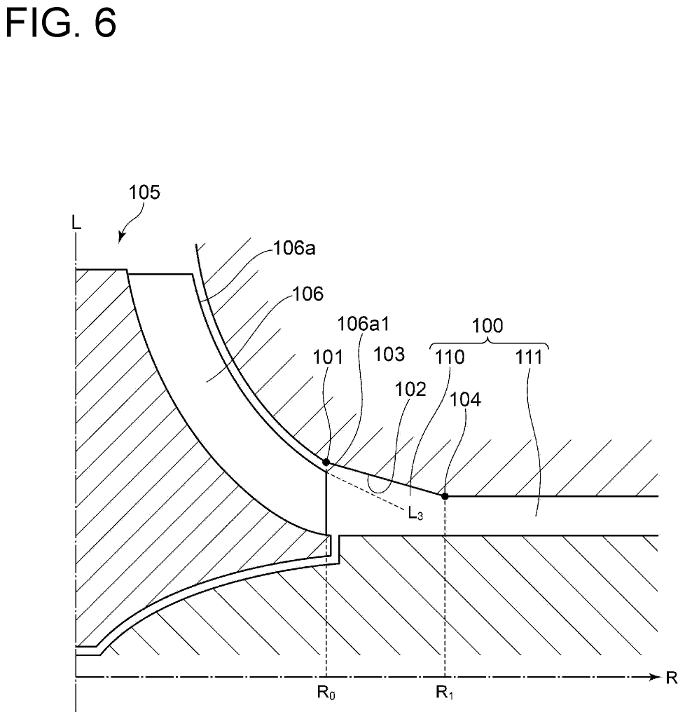

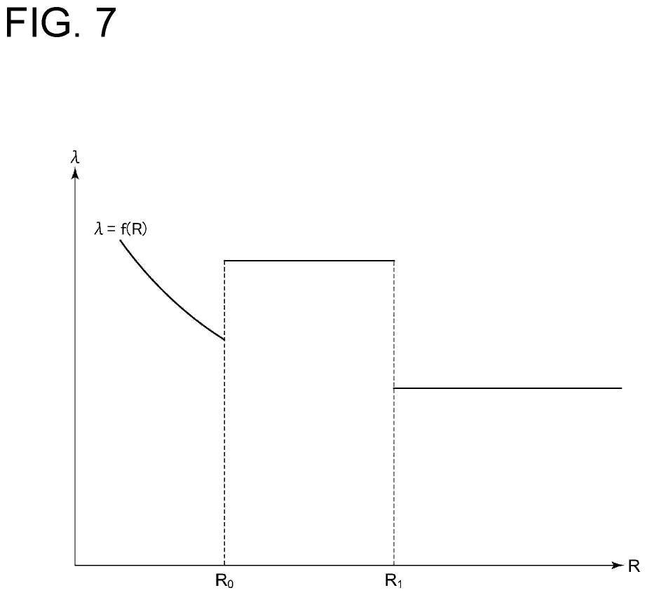

By contrast, FIG. 3 also shows the relationship between R and λ in the shroud wall 102 shown in FIG. 7, which is indicated by a single-dotted chain line, as the diffuser passage of the conventional art formed by the pinched wall. As described above, in the configuration shown in FIG. 6, the discontinuous portions exist on the shroud wall 102 in the outlet portion 101 of the impeller 105, and the boundary portion 104 between the pinched part 110 and the parallel part 111.

Thus, in the diffuser passage of the conventional art formed by the pinched wall, the relationship between R and λ in the cross-sectional shape of the surface of the shroud wall 102 is discontinuous at each of R=R₀and R=R₁. That is, a function representing the relationship between R and λ in the cross-sectional shape of the surface of the shroud wall 102 is not differentiable at each of R=R₀ and R=R₁. Further, in other words, in the cross-sectional shape of the shroud wall 102, a tangent line does not exist in the outlet portion 101 (see FIG. 6) and the boundary portion 104 (see FIG. 6).

Moreover, since the function λ=f(R) according to Embodiment 1 has a convex downward curved line in the range of R₀≤R≤R₁ where the pinched part 11 (see FIG. 2) is formed, the convex downward curved line in the range of R₀≤R≤R₁ can smoothly be connected to each of a convex downward curved line in the range of R≤R₀ and the straight line parallel to the R axis in the range of R≥R₁. Thus, it is possible to configure the pinched part 11 so the discontinuous portion is not formed in the surface 4a of the shroud wall 4.

Furthermore, the function λ=f(R) is smoothly connected to the straight line parallel to the R axis representing the constant λ in the range of R≥R₁, and thus a first-order differential coefficient f′(R1) is zero. However, in the range of R₀≤R<R₁, λ decreases with an increase in R. That is, a first derivative f′(R) of f(R) is f′(R)<0 in the range of R₀≤R₁. Thus, the shroud wall 4 (see FIG. 2) is configured to be closer to the hub wall 5 (see FIG. 2) radially outward in the pinched part (see FIG. 2).

As shown in FIG. 1, in the centrifugal compressor 1 according to Embodiment 1, air compressed by the rotation of the impeller 3 flows through the diffuser passage 10. Since the discontinuous portion does not exist in the surface 4a of the shroud wall 4 as described above, a loss or separation due to the discontinuous portion in the surface 4a does not occur when the air compressed by the rotation of the impeller 3 flows through the diffuser passage 10. Thus, it is possible to suppress the occurrence of the loss or separation in the diffuser passage 10.

### EMBODIMENT 2

Next, the centrifugal compressor according to Embodiment 2 will be described. The centrifugal compressor according to Embodiment 2 is obtained by modifying the centrifugal compressor according to Embodiment 1 in the shape of the surface 4a of the shroud wall 4 in the portion defining the pinched part 11. In Embodiment 2, the same constituent elements as those in Embodiment 1 are associated with the same reference characters and not described again in detail.

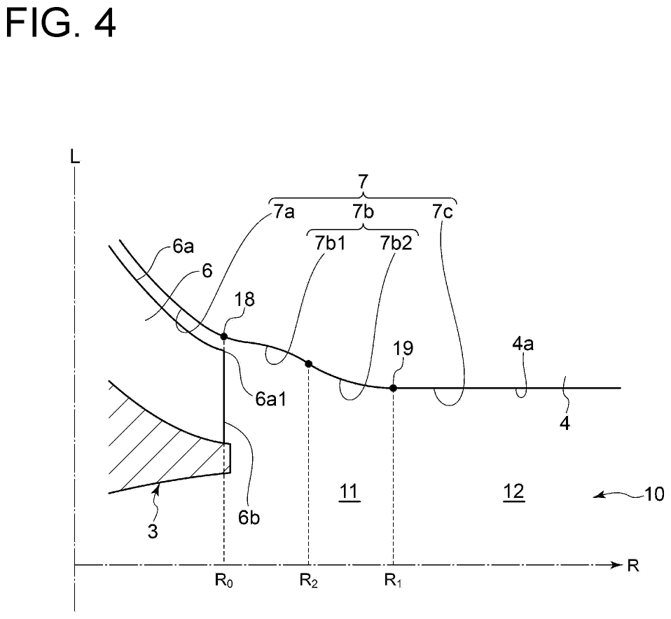

As shown in FIG. 4, in the cross-section including the axis L of the impeller 3, the curved line 7b of the cross-sectional shape 7 of the surface 4a of the shroud wall 4 includes a first curved line 7b1 and a second curved line 7b2. The first curved line 7b1 is curved into a concave shape with respect to the hub wall 5 (see FIG. 1) in the range of R₀≤R≤R₂(R₀<R₂<R₁). The second curved line 7b2 is curved into a convex shape with respect to the hub wall 5 in the range of R₂≤R≤R₁. The first curved line 7b1 and the second curved line 7b2 are smoothly connected. Other configurations are the same as Embodiment 1.

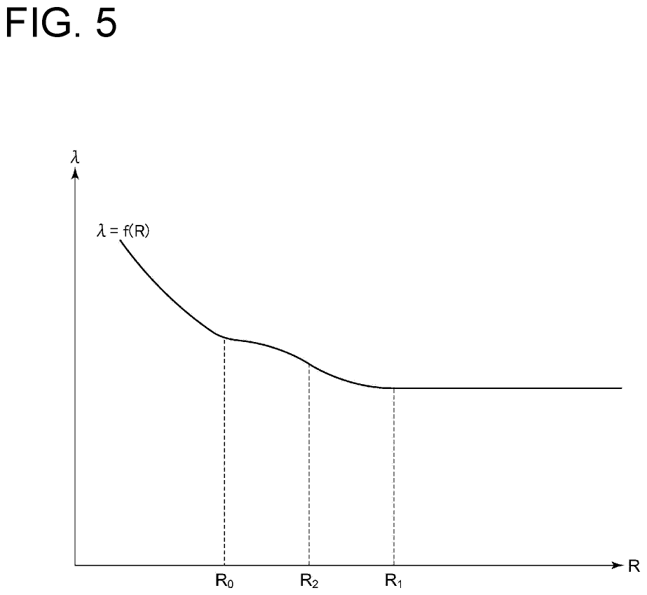

FIG. 5 shows the function λ=f(R) representing the relationship between R and λ of the cross-sectional shape 7 of the surface 4a of the shroud wall 4 in the cross-section including the axis L of the impeller 3, in the centrifugal compressor according to Embodiment 2. In the range of R≤R₀ and the range R≥R₁, of the function π=f(R) is the same as the function λ=f(R) according to Embodiment 1. On the other hand, in the range of R₀≤R≤R₂, the function λ=f(R) is a convex upward decreasing function, and in the range of R₂≤R≤R₁, the function λ=f(R) is a convex downward decreasing function.

In the Embodiment 2 as well, as described above, since the surface 4a has the smooth continuous cross-sectional shape in the cross-section including the axis L of the impeller 3 (see FIG. 4), a discontinuous point does not exist in the function λ=f(R), and the function λ=f(R) is differentiable in any R. In other words, the surface 4a can have a cross-sectional shape where the tangent line L₂ can exist at any position in the cross-section including the axis L of the impeller 3. The shape is a smooth continuous shape where the discontinuous portion does not exist.

If the curved line 7b is formed by only a curved line curved into a convex shape with respect to the hub wall 5 (see FIG. 1), in order to smoothly connect the curved line 7b and the straight line 7c, a constraint may be imposed on the shape of the diffuser passage 10. The constraint includes a need to cause the flow passage width of the parallel part 12 in the direction of the axis L to have a certain size or increasing the radial length of the pinched part 11 in order to decrease the flow passage width of the parallel part 12 in the direction of the axis L. Moreover, a case may be considered in which the shape of the blade 6 of the impeller 3 needs to be changed in order to form the diffuser passage 10 into a desired shape.

However, in Embodiment 2, since the curved line 7b includes the first curved line 7b1, which is curved into the concave shape with respect to the hub wall 5 in the range of R₀≤R≤R₂ (R₀<R₂<R₁), and the second curved line 7b2, which is curved into the convex shape with respect to the hub wall 5 in the range of R₂≤R≤R₁, it is possible to configure the pinched part 11 so a discontinuous portion is not formed in the surface 4a of the shroud wall 4 while relaxing the constraint on the shape of the diffuser passage 10, such as the constraint of the flow passage width of the parallel part 12 in the direction of the axis L or the radial length of the pinched part 11.

In the Embodiment 2 as well, since the discontinuous portion does not exist in the surface 4a of the shroud wall 4, the loss or separation due to the discontinuous portion in the surface 4a does not occur when the air compressed by the rotation of the impeller 3 flows through the diffuser passage 10. Thus, it is possible to suppress the occurrence of the loss or separation in the diffuser passage 10.

### REFERENCE SIGNS LIST

1 Centrifugal compressor

### 2 Housing

### 3 Impeller

4 Shroud wall
4a Surface (of shroud wall)
5 Hub wall

### 6 Blade

6a Outer peripheral edge part (of blade)
6a1 Radially outermost part (of outer peripheral edge part of blade)
6b Trailing edge part (of blade)
7 Cross-sectional shape (of surface of shroud wall)
7a Curved line
7b Curved line
7b1 First curved line
7b2 Second curved line
7c Straight line
10 Diffuser passage
11 pinched part
12 parallel part
18 Boundary portion
19 Boundary portion
L Axis (of impeller)

### R Distance

1.-5. (canceled)

6. A centrifugal compressor comprising an impeller rotatably disposed in a housing,
wherein the housing includes a shroud wall and a hub wall, which define a diffuser passage communicating with an outlet of the impeller,
wherein the diffuser flow passage includes:
a pinched part configured such that the shroud wall is closer to the hub wall radially outward of the centrifugal compressor from the outlet of the impeller; and
a parallel part communicating with the pinched part on a radially outer side of the centrifugal compressor than the pinched part, the parallel part being configured such that the shroud wall and the hub wall are parallel to each other,
wherein the shroud wall has a surface facing the impeller and the hub wall, the surface having a cross-sectional shape where a tangent line exists at any position in a cross-section including an axis of the impeller, and
wherein, regarding a distance R radially outward of the centrifugal compressor from the axis of the impeller, provided that R₀ is a distance from the axis of the impeller to the outlet of the impeller, and R₁ is a distance from the axis of the impeller to a boundary portion between the pinched part and the parallel part,
the cross-sectional shape in a range of R₀≤R≤R₁ is formed by a curved line including:
a first curved line curved into a concave shape with respect to the hub wall in a range of R₀≤R≤R₂(R₀<R₂<R₁); and
a second curved line curved into a convex shape with respect to the hub wall in a range of R₂≤R≤R₁.

7. The centrifugal compressor according to claim 6,
wherein, provided that, in the cross-section including the axis of the impeller, λ is an angle between the tangent line and a straight line obtained by extending a radially outermost part of an outer peripheral edge part of a blade in the impeller radially outward, λ=f(R) represents a relationship between the R and the λ by a function f in a range of R₀≤R≤R₁, and f′(R) is a first derivative of f(R), f′(R)<0 holds in the range of R₀≤R<R₁.

8. A turbocharger comprising the centrifugal compressor according to claim 6.
